(19) United States
(12) Patent Application Publication
(10) Pub. No.: US 2008/0290649 A1
(43) Pub. Date: Nov. 27, 2008

(54) Laser Transfer of Security Features

(76) Inventors: Sylke Klein, Rossdorf (DE); Klaus-Christian Ullmann, Bensheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/095,401

(22) PCT Filed: Nov. 24, 2006
(86) PCT No.: PCT/EP2006/011311

§ 371 Date: May 29, 2008

(30) Foreign Application Priority Data
Nov. 30, 2005 (DE) 10 2005 057 474.2

(51) Int. Cl. B42D 15/00

(52) U.S. Cl. 283/86

(57) ABSTRACT

The present invention relates to a process for increasing the counterfeiting protection of high-value products, documents of value and security documents by means of uncopyable security features which are transferred into the respective material with the aid of laser technology.

The present invention relates to a process for increasing the counterfeiting protection of high-value products, documents of value and security documents by means of uncopyable security features which are transferred into the respective material with the aid of laser technology. The invention likewise relates to a suitable support-film system for carrying out the process.

The term “uncopyable” here is taken to mean that, on counterfeiting of the product, document of value or security document by photocopying, the specific property of the security feature, such as, for example, fluorescence, phosphorescence, electroluminescence, specific conductivity, colour flop, UV and IR absorption, DNA sequences or properties based on magnetic, thermochromic, holographic or photochromic effects, is not reproduced on the copies.

In accordance with the current state of the art, it is possible to label materials, such as glass, ceramic, metal and plastics, with the aid of laser technology in colours which are visible to the human eye and are easy to copy. Processes of this type are described, for example, in the applications WO 99/16625, WO 99/25562, U.S. Pat. No. 6,238,847, DE 101 36 479 A1, DE 199 42 316 A1, DE 10 2004 053 376 A1 and DE 10 2004 016 037 A1.

Especially for documents of value and security documents, laser technology is also used for laser ablation and/or blackening of printing inks or the document itself and for the production of tactile markings, as known from the applications DE 28 36 529, WO 98/03348 and WO 2004/009371.

In contrast to printing processes with a pre-specified print image, such as, for example, screen printing, template printing, intaglio printing, flexographic printing, offset printing, gravure printing and pad printing, computer-controlled laser technology offers the possibility of labelling each individual product or document individually and in a personalised manner.

In contrast to digital printing processes, such as thermal transfer or ink-jet printing, freely movable laser heads make the process virtually independent of the product geometry.

The object of the present invention is to develop a process for the flexible and individual labelling of high-value products, such as, for example, documents of value and security documents, with counterfeiting- and copy-proof features using laser technology.

Surprisingly, it has been found that security features incorporated into a suitable layer system can be transferred into the product or into the document of value or security document—referred to simply as document below—by means of laser radiation. The laser energy input is absorbed here by a laser-sensitive material and converted into heat energy. The action of heat on the layer system results in detachment of the security features and transfer thereof into or onto the product or document to be labelled.

The present invention thus relates to a process for the flexible and individual labelling of products, documents of value and security documents with counterfeiting- and copy-proof features, characterised in that uncopyable security features are incorporated into a layer system and transferred into or onto the product, document of value or security document by means of laser radiation.

An advantage for product and document counterfeiting protection compared with known techniques, such as printing processes, consists in that the laser radiation used may also cause warming in the product or document itself, and the security features can thus be transferred not only onto the surface, but also into the product or document down to a certain depth.

Lasers in the wavelength range from 157 nm to 10.6 μm, preferably in the range from 355 nm to 10.6 μm, come into consideration for this purpose. Particular preference is given to the use of diode lasers (808-980 nm), Nd:YAG and YVO₄ lasers (355, 534 and 1064 nm) and CO₂ lasers (10.6 μm). Laser transfer is possible both in continuous-wave mode and also in pulsed mode. The suitable power spectrum of the laser ranges from 0.5 to 300 watts (average laser output power), particularly preferably in the range from 14 to 30 W, and the pulse frequency is in the range from 1 to 200 kHz.

The parameters of the laser used depend on the particular application and can readily be determined by the person skilled in the art.

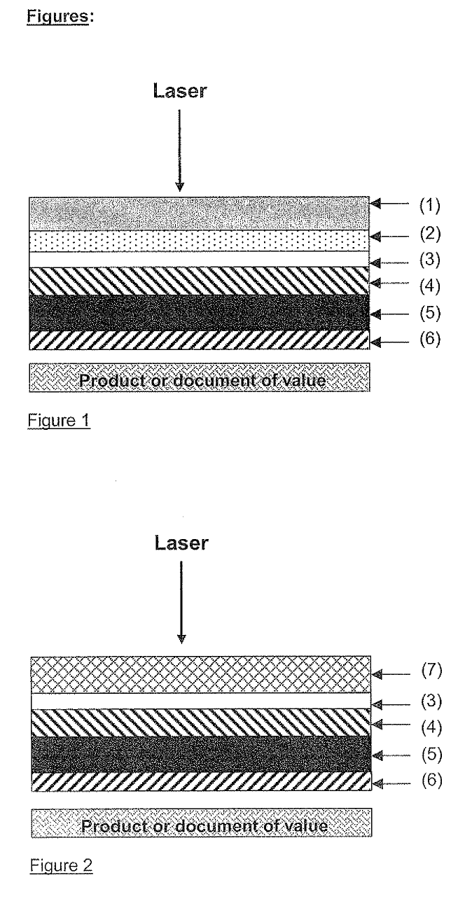

In the process according to the invention, the layer system in a preferred embodiment, as depicted in FIG. 1, consists of at least four layers lying one on top of the other, where the first layer is a support film (1) which is trans-parent to laser light, to which an energy absorber layer (2) which is sensitive to laser light is applied, subsequently the detachment layer (3), optionally a sealing layer (4), the inscription medium (5) and optionally an adhesive layer (6) as the final layer, where the inscription medium comprises copy-proof security features, and the laser energy is absorbed by the laser-sensitive substance and converted into heat energy and results in detachment of the security features and transfer thereof into or onto the document of value or security document to be labelled.

In a further preferred embodiment, depicted in FIG. 2, the layer system consists of at least three layers lying one on top of the other, where the first layer is a support film (7) which is transparent to laser light and comprises one or more energy absorbers which are sensitive to laser light, subsequently the detachment layer (3), optionally a sealing layer (4), the inscription medium (5) and optionally an adhesive layer (6) as the final layer, where the inscription medium comprises copy-proof security features, and the laser energy is absorbed by the laser-sensitive substance and converted into heat energy and results in detachment of the security features and transfer thereof into or onto the document of value or security document to be labelled.

The invention likewise relates to support-film systems which are suitable for the process.

The principal components of the layer system according to the invention (FIGS. 1 and 2) are a suitable support-film system, a laser-sensitive substance and the desired copy-proof security feature in an inscription medium.

Materials which come into consideration for the support-film systems (1) in FIG. 1 or (7) in FIG. 2 are preferably plastic films which are not destroyed by the laser light.

Suitable plastics are polyesters, such as polyethylene terephthalate, polyolefins, such as polyethylene and polypropylene, polyamides, polyimides, polyacetals, polycarbonates, polyester-esters, polyether-esters, polymethyl methacrylates, polyvinyl acetal, polyvinyl chloride, polystyrene, acrylonitrile-butadiene-styrene, acrylonitrile-styrene-acrylate, polyether ketones, polyether sulfones, and copolymers and/or mixtures thereof.

Of the said plastics, plastic films made from polyethylene terephthalate, polyethylene and polypropylene are particularly suitable.

The laser-sensitive substance is applied to the support-film system (1) as layer (2) in FIG. 1 or is already present in the support-film system (7) in FIG. 2. In the latter case, the support film (7) is then no longer transparent or translucent to the laser light, but must still be stable during the laser irradiation.

The laser-sensitive substance can be incorporated by:
homogeneous colouring of the support film, i.e. with a constant degree of filling of laser-sensitive material within the support-film system, or
gradual colouring of the support film, i.e. with a gradient in the degree of filling of laser-sensitive material.

The support-film systems (1) and (7) may additionally be bonded to or embedded in uncoloured films in order to prevent potential bleeding of the laser-sensitive material into the inscription medium.

The support-film system can be assembled using processes known to the person skilled in the art, such as, for example, cold and warm adhesive bonding, extrusion, calendering and lamination.

Laser-sensitive substances that can be used are all materials which absorb the laser energy to a sufficient extent in the wavelength range indicated and convert it into heat energy.

The laser-sensitive substances which are suitable for the invention are preferably materials selected from the group carbon, carbon black, metal oxides, such as, for example, Sn(Sb)O₂, TiO₂, graphite, anthracene, IR-absorbent colorants, such as, for example, perylenes/rylenes, pentaerythritol, copper hydroxide phosphates, molybdenum disulfides, antimony(III) oxide and bismuth oxychloride, flake-form, in particular transparent or semitransparent substrates comprising, for example, phyllosilicates, such as, for example, synthetic or natural mica, talc, kaolin, glass flakes, SiO₂ flakes or synthetic support-free flakes. Also suitable are flake-form metal oxides, such as, for example, flake-form iron oxide, aluminium oxide, titanium dioxide, silicon dioxide, LCPs (liquid crystal polymers), holographic pigments, conductive pigments, coated graphite flakes or mixtures thereof.

Flake-form pigments which can be employed are also metal powders, which may be uncoated or also covered with one or more metal-oxide layers; preference is given to, for example, Al, Cu, Cr, Fe, Au, Ag and steel flakes. If corrosion-susceptible metal flakes, such as, for example, Al, Fe or steel flakes, are to be employed in uncoated form, they are preferably covered with a protective polymer layer.

Besides flake-form substrates, it is also possible to employ spherical pigments, for example comprising Al, Cu, Cr, Fe, Au, Ag and/or Fe.

Particularly preferred substrates are mica flakes coated with one or more metal oxides.

The metal oxides used here are both colourless high-refractive-index metal oxides, such as, in particular, titanium dioxide, antimony(III) oxide, zinc oxide, tin oxide and/or zirconium dioxide, and also coloured metal oxides, such as, for example, chromium oxide, nickel oxide, copper oxide, cobalt oxide and in particular iron oxide (Fe₂O₃, Fe₃O₄). The laser-sensitive component used is particularly preferably antimony(III) oxide, alone or in combination with tin oxide.

These substrates are known and the majority are commercially available, for example under the trade name Iriodin® Lazerflair from Merck KGaA, and/or can be prepared by standard processes known to the person skilled in the art.

Pigments based on transparent or semitransparent flake-form substrates are described, for example, in the German patents and patent applications 14 67 468, 19 59 998, 20 09 566, 22 14 454, 22 15 191, 22 44 298, 23 13 331, 25 22 572, 31 37 808, 31 37 809, 31 51 343, 31 51 354, 31 51 355, 32 11 602, 32 35 017, 38 42 330, 44 41 223.

Coated SiO₂ flakes are, for example, known from WO 93/08237 (wet-chemical coating) and DE-A 196 14 637 (CVD process).

Multilayered pigments based on phyllosilicates are known, for example, from the German applications DE 196 18 569, DE 196 38 708, DE 197 07 806 and DE 198 03 550. Particularly suitable are multilayered pigments having the following structure:

mica+TiO₂+SiO₂+TiO₂

mica+TiO₂+SiO₂+TiO₂/Fe₂O₃

mica+TiO₂+SiO₂+(Sn, Sb)O₂

SiO₂flake+TiO₂+SiO₂+TiO₂

Particularly preferred laser-sensitive substances are carbon blacks, such as flame black and gas black.

The laser-sensitive substance may also be a mixture of two or more of the said components.

If the laser-sensitive substance is applied, for example printed, onto the support (1) as layer (2) (FIG. 1), it is preferably present in a proportion of 0.5-40% by weight, preferably 5-38% by weight, in particular 7-35% by weight, based on the total weight of the liquid printing medium.

If the laser-sensitive substance is incorporated, for example extruded and calendered, directly into the support (7) in FIG. 2, it is present in the support (7) in a proportion of effectively 0.5-10% by weight, preferably 1-8% by weight, in particular 1.5-6% by weight.

The inscription medium (5) with the desired security feature is applied as layer to the support-film system and essentially consists of binder system (the binder has generally already been introduced into suitable solvents and can be purchased commercially), security feature, fillers and optionally colorants and additives.

The inscription medium preferably comprises 20-90% by weight of binder system, in particular 40-85% by weight and very particularly preferably 60-80% by weight, based on the total weight of the inscription medium.

Binders known to the person skilled in the art for the inscription medium are, in particular, cellulose, cellulose derivatives, such as, for example, cellulose nitrate, cellulose acetate, hydrolysed/acetalated polyvinyl alcohols, polyvinylpyrrolidones, polyacrylates, and also copolymers of ethylene-ethylene acrylate, polyvinylbutyrals, epoxy resins, polyesters, polyisobutylene, polyamides.

The use of colorants depends on whether it is also desired to apply a clearly visible mark/inscription to the product or document in addition to the uncopyable security feature.

In particular, the following come into consideration as counterfeiting-proof, uncopyable security features which may be present in the inscription medium (5):

TABLE 1
Security pigments, dyes

| Material for | | | |
|---|---|---|---|
| security feature | Excitation by | Emission of | Examples of security feature materials |
| IR pigment, dye, | IR | IR | Amino-functionalised coumarins, |
| IR upconverter, | IR | VIS | perylenetetracarboxylic diimides, |
| IR downconverter, | VIS | NIR | anthracenes, oxysulfides and oxy- |
| IR pigment, dye | IR | Detection of | chlorides/fluorides of rare-earth metals, |
| with unambiguously | | the missing | metal/heavy-metal halides doped with |
| detectable absorp- | | absorption | rare-earth metals (for example Na (Y, Nd, |
| tion | | lines | Er, Tm, Yb) F₄: doping atom) |
| Primary/secondary | UV (part. λ) | UV | Polycyclic compounds, such as uranin, |
| UV fluorescent | UV + water, | UV | coumarins and derivatives (rhodamines, |
| pigment, dye | acid or base | | eosines), rare-earth metal complexes (Eu, |
| | | | Gd, Ru), naphthopyrans, spirooxazines, |
| | | | quinolines, pyrenes, thiophenes |
| Phosphorescent | UV | Phosphores- | ZnS—, alkaline earth metal aluminate- |
| pigment, dye | | cence in the | based pigments, phosphors |
| | | VIS | |
| Laser dye | Flash lamps, | UV to NIR | Scintillator dyes, coumarins, rhodamines, |
| | lasers | | cyanines, rylenes, pyrromethenes |
| Photochromic | UV or strong | VIS | Pyranines, pyronine derivatives, |
| pigment, dye | daylight | | perylenes, coumarins, stilbenes, |
| | | | rhodamines, pyrrolopyrroles, quinolines, |
| | | | Tinopals, eosines and uranin, rare |
| | | | alkaline-earth metal complexes |
| Thermochromic | Temperature | Colour | Liquid crystals, ZnO, mercury(II) iodide, |
| pigment, dye | change | change in the | silver iodomercurate, cobalt(II) chloride, |
| | | VIS | leucodyes |
| Electroluminescent | Electrical | VIS | Dialkoxy-substituted poly-p-phenylene- |
| polymer, dye | pulse | | vinylene, oligothiophenes, luminophores, |
| | | | phosphor compounds |
| Optically variable | Change in | Colour | Oxide-coated mica, SiO₂ or glass flakes |
| pigment | viewing angle | change | |
| | | within VIS | |
| Iridescent pigment | Change in | Rainbow | Coated mica, SiO₂ or glass flakes |
| (pearlescence) | viewing angle | effect within | |
| | | VIS, pearly | |
| | | lustre | |

| | | |
|---|---|---|
| Taggants | Depending on the functional | IR taggants, synth. DNA, organic mole- |
| | principle of the taggant | cules, micro- or nanocrystalline particles |
| | | having a certain shape, colour (micro- |
| | | taggants), fluorescent particles, magnetic |
| | | particles (iron oxides), biotaggants |
| Conductive pigment | Reading of the data by RF | Silver-, copper- or carbon-based printing |
| | | inks |
| Magnetic pigment | External magnetic field | Magnetic particles (iron oxides), iron- |
| | | oxide-coated flakes, such as, for example, |
| | | mica |
| Holographic | Change in viewing angle | Vapour-deposited or sputtered Al layers |
| pigment | | |

IR: infrared wavelength range (300 μm to 770 nm),
NIR: near infrared
VIS: visible range (770 to 390 nm)
UV: ultraviolet wavelength range (390 nm to 5 nm)
RF: radio frequency (30 to 500 kHz (LF), 10 to 15 MHz (HF), 850 to 950 MHz (UHF))

The security feature is generally present in the inscription medium in amounts of 0.001-40% by weight. In the case of holographic applications, pure (100%) aluminium layers are necessary in order to achieve an effect. In the case of colour-flop pigments, the concentrations are in the range 20-30% by weight, while concentrations in the ppm range are sufficient in the case of taggants.

Highly suitable for the application of the respective security feature are, for example, printing media into which the security pigments/dyes have been incorporated in pure form or in the form of nano- or microcrystalline particle systems. The security pigments/dyes can be distributed homogeneously or also separately, for example in different layers, in the particle matrix (for example plastic matrix).

Plastics homogeneously coloured with these security pigments/dyes can likewise serve as coating material for inorganic powders or flakes (synthetic or natural mica, talc, kaolin, glass flakes or powder, SiO₂ flakes or powder, nano- or microparticles, metal oxides), which are likewise applied to the support-film system (1) or (7) by printing or coating processes.

Suitable plastics for the particle systems or coatings having security features are polystyrene, polyacrylonitrile, polymethyl methacrylate and melamine-alkyd polymers, and cured plastic resins, such as melamine-formaldehyde resins.

A detachment layer (3) and a sealing layer (4) can optionally be inserted between the laser-sensitive layer (2) or the support system (7) and the inscription medium (5).

The detachment layer (3) simplifies clean detachment and transfer of the security feature during laser transfer. It essentially consists (>95% by weight) of waxes. Natural waxes, such as, for example, carnauba, candelilla and montan wax, and synthetic waxes, such as, for example, polyolefin waxes and paraffin waxes, having a melting point of 50-140° C., but preferably having a melting point of 75-120° C., are suitable.

The sealing layer (4) offers additional protection of the transferred security feature in the inscription medium (5) against the respective external influences. However, the sealing layer (4) is not absolutely necessary.

The sealing is carried out with the aid of transparent layers of polymers, which preferably have glass transition temperatures ≧90° C., in particular between 100 and 120° C. This polymer layer can be applied as a separate layer or may already surround and thus seal the security features in the inscription medium (5). The sealing layer preferably consists of the polymers of styrene, vinyl chloride, vinyl fluoride, methyl methacrylate or hydroxy-functional acrylates.

In order to support the laser transfer of the inscription medium (5) from the film support system into the product or document, an adhesive layer (6), which is either activated under the action of a laser or already has adhesive properties, can optionally be applied to the inscription medium (5).

The adhesive layer (6), if present, essentially consists (>95% by weight) of thermoplastics and fillers. It is designed in such a way that an adhesive strength and thus adhesion only develops under the action of a laser.

Preferred thermoplastics used are polyvinyl chloride, modified colophony resin, polyethylene-vinyl acetate, ethylene-vinyl acetate terpolymers, chlorinated polypropylene and polyethylene, polyesters and polyurethanes.

The fillers used are preferably chalk, calcite, calcium carbonate, barium sulfate and precipitated silicic acid (SiO₂). The preferred filler: thermoplastic ratio is 1:0.5 to 1:1.

Suitable for adhesive layers having adhesive properties are all adhesives for film systems based on PUR, acrylate or rubber, in particular two-component polyurethane adhesives, crosslinked acrylate hot-melt adhesives having K values >20 (Acronal® adhesive grades, BASF) and also resins based on colophony and hydrocarbon resins.

The adhesive layer (6) is applied to the inscription medium (5) in a layer thickness of 0.3 to 10 μm, particularly preferably in a layer thickness of 0.5 to 2 μm.

The layer system has a total layer thickness of 30-350 μm, preferably 40-300 μm, in particular 50-250 μm.

With the aid of the laser transfer according to the invention of copy-proof security features, it is possible to provide
products, in particular proprietary articles and industrial goods made from plastic, plastic films, leather, wood and textiles,
product packaging and labels made from paper, cardboard, board, plastic or plastic films,
documents of value made from paper, cardboard, board, plastics, plastic films and laminates, such as bank notes, bank and credit cards, cheques, cheque cards, securities, deeds, identity cards, value and postal stamps, certificates, identification cards, test certificates, rail and air tickets, entry tickets, telephone cards, etc.
   with counterfeiting- and copy-proof protection.

With respect to the spatial positioning, the security feature can be in the form of a hidden feature in a visible inscription field and be rendered visible by means of the corresponding technical aids or it is located in an unknown place on the product or document which is not visibly marked.

The following examples are intended to explain the invention, but without restricting it.

All percentages in the description and examples are percent by weight, unless indicated otherwise.

### WORKING EXAMPLES

### Example 1

### Production of a Support Film (1) which is Homogeneously Coloured Black

Masterbatches of polyethylene (PE), polypropylene (PP) or polyethylene terephthalate (PET) having carbon-black contents of 3-12% by weight are converted in conventional production processes, such as extrusion and calendering, into films, which are subsequently biaxially stretched. The effective carbon-black content of a suitable PE film is between 2.5 and 5% by weight.

The film homogeneously coloured black may additionally be bonded to an uncoloured film of polyethylene terephthalate. For example, black-coloured PE, PET or PP is extruded onto a PET film having a thickness of 12 μm at processing temperatures of 120-160° C. and subsequently calendered. The application weights of the black-coloured PE, PET or PP are between 20 and 50 g/m². The thickness of the finished laminate is between 20 and 80 μm.

Alternatively, the laminate of the support films can be produced by hot lamination of the black-coloured PE, PET or PP film to the PET film at about 140° C. or cold lamination using commercially available adhesives (acrylate adhesives, 2-component polyurethanes or hot melts).

The support-film system is subsequently coated with inscription medium and optionally with detachment, sealing and adhesive layers.

### Example 2

### Production of a Support Film (7) Gradually Coloured Black (with Gradients in the Degree of Filling)

Firstly, individual masterbatches of polyethylene (PE), polypropylene (PP) or polyethylene terephthalate (PET) having carbon-black or iron-oxide contents of 3-15% are prepared.

For a film gradually coloured black, the first step is the production of the unfilled or most highly filled film as base film, and the subsequent degree-of-filling stages (for example in 1% steps) are extruded onto this base film and calendered.

Another variant consists in producing the films having the different degrees of filling individually and laminating them as described in Example 1 to give a laminate.

In addition, the film gradually coloured black can also—as already described in detail in Example 1 for the film homogeneously coloured black—be laminated on both sides to an uncoloured film of polyethylene terephthalate or bonded thereto.

The thickness of the finished laminate is 20-80 μm.

The support-film system is subsequently coated with inscription medium and with detachment, sealing and adhesive layers.

### Example 3

### Production of a Laser-Sensitive Layer (2)

74-80.0% by weight of ethyl acetate
6-6.5% by weight of PVB (polyvinylbutyral, Pioloform®, Wacker-Chemie)
13.5-20.0% by weight of Sn(Sb)O₂ (d₅₀ value <1.1 μm) (Du Pont)

Polyvinylbutyral is dissolved in the initially introduced solvent ethyl acetate and stirred well. The laser-sensitive component Sn(Sb)O₂ is subsequently stirred in, and a homogeneous ink is prepared.

The ink is printed onto the support film (1) or (7) by gravure printing at an application rate of 0.5-10 g/m².

### Example 4

### Production of a Laser-Sensitive Layer (2)

74.0-80.0% by weight of ethyl acetate
6.0-6.5% by weight of PVB (polyvinylbutyral, Pioloform®, Wacker-Chemie)
13.5-20.0% by weight of gas black (d₅₀ value <17 nm) (Special Black 6, Degussa)

The processing is carried out as described in Working Example 3. The laser-sensitive component employed is gas black.

### Example 5

### Production of a Laser-Sensitive Layer (2)

44.0-45.0% by weight of Masterblend 50 (SICPA-AARBERG AG)
30.0-35.0% by weight of Iriodin® Lazerflair 825 (particle size <20 μm) (Merck KGaA)
20.0-25.0% by weight of ethyl acetate/ethanol (1:1)

The laser-sensitive material Iriodin® Lazerflair 825 is introduced gently into the print medium Masterblend 50 and printed by gravure printing. The desired viscosity can be set using the solvent mixture ethyl acetate/ethanol. The application rate is 0.5-1 g/cm².

### Example 6

### Production of a Detachment Layer (3)

80% by weight of toluene
15% by weight of methyl ethyl ketone (MEK)
5% by weight of ester wax (drop point 90° C.)

The ester wax is dissolved in the solvent mixture and stirred well.

### Example 7

### Production of a Detachment Layer (3)

99.5% by weight of toluene
0.5% by weight of ester wax

The ester wax is dissolved in toluene and stirred well.

### Example 8

### Production of a Sealing Layer (4)

55-60% by weight of xylene
25-30% by weight of polystyrene
10-15% by weight of PE wax

The PE wax and polystyrene are dissolved in xylene and homogenised using a dissolver.

### Example 9

### Production of a Sealing Layer (4)

75-80% by weight of n-butyl acetate
15-20% by weight of polystyrene
0.5-1% by weight of ethylcellulose
0.5-1% by weight of UV stabiliser

The processing is carried out as described in Example 8.

### Example 10

### Production of a Sealing Layer (4)

40.0% by weight of methyl ethyl ketone
23.0% by weight of toluene
10.0% by weight of cyclohexanone
19.5% by weight of PMMA (T_{g}: 122° C.) (Degussa)
7.5% by weight of PE wax

The PE wax and PMMA are dissolved in the solvent mixture and homogenised using a dissolver.

### Example 11

### Preparation of a Coating Medium (5) Comprising Secutag® Taggants from Simons Druck+Vertrieb GmbH, Nottuln

Various grades of Secutag® colour-coding particles having different particle-size distributions are used. Particle-size range is between 5 and 45 μm.
0.1-5 P of Secutag colour-coding particles
10 P of Colorcode turquoise-lilac (colour-flop pigment from Merck KGaA)
60-80 P of Bargofor gravure-printing binder (SICPA)

The respective colour-coding grades are stirred into the binder system together with the pearlescent effect pigment white avoiding high shear forces. The print viscosity is subsequently set (DIN 4 cup (DIN 53211) 14-25 s).

35 g of ethoxypropanol are added to 65 g of printing-ink concentrate (see above).

The ink is printed by gravure printing using a suitable gravure screen (for example 60 lines/cm, electronically engraved) on a suitable printing machine (for example Moser-Rototest). The layer thickness is 4-8 μm.

### Example 12

### Preparation of a Coating Medium (5) Comprising IR Upconverters from Stardust

Various grades of so-called “up-converting luminescent phosphors” from Stardust (Bellevue, Wash., USA) are employed.

### 1. Z0011

### 2. P0013

### 3. F0027

### 4. K0080

### 5. Y0037

Particle-size range is between 2 and 10 μm.

1-10 P of fine grade up-converting luminescent phosphor
5-30 P of Colorcode turquoise-lilac
60-80 P of Bargofor gravure-printing binder (SICPA)

The respective upconverter is stirred into the binder system together with the pearl-effect pigment while avoiding high shear forces. The print viscosity is subsequently set (DIN 4 cup (DIN 53211) 14-25 s).

35 g of ethoxypropanol are added to 65 g of printing-ink concentrate (see above).

The ink is printed by gravure printing using a suitable gravure screen (for example 60 lines/cm, electronically engraved) on a suitable printing machine (for example Moser-Rototest). The layer thickness is 4-8 μm.

### Example 13

### Preparation of a Coating Medium (5) Comprising UV-Fluorescent Dyes

Various grades of UV-fluorescent dyes from Nanosolutions (Hamburg) are employed in combination with pearl-effect pigments from Merck.

1. REN-X UC green
2. REN-X green

### 3. REN-X red

for example 10-30 P of Colorcode turquoise-lilac
60-80 P of Bargofor gravure-printing binder (SICPA)

The respective fluorescent dye is stirred into the binder system together with the pearl-effect pigment while avoiding high shear forces. The print viscosity is subsequently set (DIN 4 cup (DIN 53211) 14-25 s).

35 g of ethoxypropanol are added to 65 g of printing-ink concentrate (see above).

The ink is printed by gravure printing using a suitable gravure screen (for example 60 lines/cm, electronically engraved) on a suitable printing machine (for example Moser-Rototest). The layer thickness is 4-8 μm.

### Example 14

### Preparation of a Coating Medium (5) Comprising Magnetic Particles (Mica Pigments Coated with Iron Oxide)

### 1. Colorona® Blackstar Gold (Merck KGaA)

### 2. Colorona® Blackstar Silver (Merck KGaA)

### 3. Colorona® Blackstar Blue (Merck KGaA)

### 4. Colorona® Blackstar Red (Merck KGaA)

10-30 P of Colorona® Blackstar (pearlescent pigment, Merck KGaA)
60-80 P of Bargofor gravure-printing binder (SICPA)

The respective pigment is stirred into the binder system while avoiding high shear forces. The print viscosity is subsequently set (DIN 4 cup (DIN 53211) 14-25 s).

35 g of ethoxypropanol are added to 65 g of printing-ink concentrate (see above).

The ink is printed by gravure printing using a suitable gravure screen (for example 60 lines/cm, electronically engraved) on a suitable printing machine (for example Moser-Rototest). The layer thickness is 4-8 μm.

### Example 15

### Preparation of a Coating Medium (5) Comprising Iridescent Pigments (Interference Pigments)

The pigment Iriodin® 201 in an amount of 30% by weight is stirred into the binder system while avoiding high shear forces. The print viscosity is subsequently set (DIN 4 cup (DIN 53211) 14-25 s).

35 g of ethoxypropanol are added to 65 g of printing-ink concentrate (see above).

The ink is printed by gravure printing using a suitable gravure screen (for example 60 lines/cm, electronically engraved) on a suitable printing machine (for example Moser-Rototest). The layer thickness is 4-8 μm.

### Example 16

### Preparation of a Coating Medium (5) Comprising Optically Variable Pigments

20-25% by weight of Viola Fantasy pigment (Merck KGaA)
75% by weight of nitrocellulose/alcohol blend

The pigment is stirred into the binder system while avoiding high shear forces. The print viscosity is subsequently set (DIN 4 cup (DIN 53211) 14-25 s).

35 g of ethoxypropanol are added to 65 g of printing-ink concentrate (see above).

The ink is printed by gravure printing using a suitable gravure screen (for example 60 lines/cm, electronically engraved) on a suitable printing machine (for example Moser-Rototest). The layer thickness is 4-8 μm.

### Example 17

### Preparation of a Coating Medium (5) Comprising UV-Fluorescent Particles (Taggants)

40-45% by weight of Senolith® emulsion paint (Weilburger Graphics GmbH)
30-35% by weight of Sandopers Yellow E-HRD (Clariant)
0.0001-1% by weight of melamine particles (particle size 1-5 μm), coloured with, for example, rhodamine B

The aqueous pigment preparation is introduced into the emulsion paint. The spherical melamine particles, which fluoresce in UV light, are prepared in a polycondensation reaction in aqueous rhodamine B solution, washed, filtered and mixed into the coating medium by stirring.

Owing to the small particle size and the melamine particles, which are only needed in very low concentration, this is a feature which is truly hidden and can only be detected under the UV microscope.

With increasing particle size and concentration, the melamine particles become visible under commercially available UV lamps.

Larger melamine particles can be obtained if support substrates, such as mica flakes or the like, are coated with fluorescent melamine resins.

### Example 18

### Production of an Adhesive Layer (6)

18% by weight of acetone
62% by weight of toluene
3% by weight of chlorinated polyolefin
5% by weight of polyvinyl chloride (Tg 76° C.)
2% by weight of colophony-modified resin (softening point 92° C.)
10% by weight of silicon dioxide

The processing is carried out as described in Example 8.

The softening point and glass transition temperature are determined in accordance with DIN EN 6032 and DIN EN ISO 306 respectively.

### Example 19

### Production of a Multilayered Inscription Tape

A detachment layer (3) (Examples 6-7) in a layer thickness of 0.01-2 μm is optionally applied to a support-film laminate described in Example 1 or 2 (Examples 3-5) comprising intrinsically present laser-sensitive pigment (7) or separately applied laser-sensitive layer (2).

Depending on the application, the coating can then be carried out with a sealing layer (4) (Examples 8-10) in a layer thickness of 0.01-2 μm.

The inscription medium (5) (Examples 11-17) can subsequently be printed in a layer thickness of 2-15 μm onto the detachment layer (3) or sealing layer (4) and dried at 70-120° C.

In a further step, the adhesive layer (6) (Example 18), which, depending on the application, can be between 0.3 and 10 μm, but is preferably employed in a range from 0.5 to 2 μm, is then applied. The preferred printing process is gravure printing.

### Example 20

### Laser Marking and Inscription with Security Features

The inscription films should be brought into close contact with the products and documents to be inscribed. This can be carried out, for example, by mechanical feeding of the inscription films in an unrolling device to the product or document or by application of a vacuum, which sucks the inscription film against the product or document. In the case of adhesive layers, manual adhesion is also possible.

The following lasers and laser parameters are preferred.

TABLE 2
Laser parameters

| | Average | Wave- | Focal | Laser | | |
|---|---|---|---|---|---|---|
| Laser | output | length | length | intensity | Speed | Operating |
| type | power [W] | [μm] | [mm] | [%] | [mm/s] | mode |
| Nd-YAG | 12 | 1.064 | 163 | 50-95 | 100-5000 | cw |
| Nd—YVO₄ | 16 | 1.064 | 163 | 50-95 | 100-5000 | QS (5- |
| | | | | | | 100 kHz) |
| CO₂ | 25 | 10.6 | 150; | 40-70 | 250-1200 | cw |
| | | | 250 | | bits/ms | |
| Nd—YVO₄ | 4 | 0.532 | 160 | 50-95 | 100-1500 | QS (10- |
| | | | | | | 100 kHz) |
| Nd—YVO₄ | 1.5 | 0.355 | 160 | 50-95 | 100-500 | QS (10- |
| | | | | | | 100 kHz) |

1. Process for the flexible and individual labelling of products, documents of value and security documents with counterfeiting- and copy-proof features, characterised in that uncopyable security features are incorporated into a layer system and transferred into or onto the product, document of value or security document by means of laser radiation.

2. Process according to claim 1, characterised in that the laser energy is absorbed by a laser-sensitive substance and converted into heat energy and results in detachment of the security features and transfer thereof into or onto the document of value or security document to be labelled.

3. Process according to claim 1, characterised in that the laser-sensitive substance is selected from the group carbon, carbon black, metal oxides, graphite, anthracene, pentaerythritol, copper hydroxide phosphates, molybdenum disulfides, antimony(III) oxide and bismuth oxychloride, phyllosilicates, synthetic or natural mica, talc, kaolin, glass flakes, SiO₂ flakes, synthetic support-free flakes, flake-form metal oxides, silicon dioxide, LCPs (liquid crystal polymers), holographic pigments, pearlescent pigments, multilayered pigments based on flake-form substrates coated with two or more metals and/or metal oxides, conductive pigments, coated graphite flakes, metal flakes, spherical pigments comprising Al, Cu, Cr, Fe, Au, Ag and Fe, and mixtures thereof.

4. Process according to claim 1, characterised in that the uncopyable security feature is selected from the group IR pigment, IR dye, IR upconverter, IR downconverter, primary and secondary UV fluorescent pigment or dye, phosphorescent pigment, phosphorescent dye, laser dye, photochromic pigment, photochromic dye, thermochromic pigment, thermochromic dye, electroluminescent polymer, electroluminescent dye, optically variable pigment, pearlescent pigment, taggants, conductive pigment, holographic pigment, magnetic pigment or mixtures thereof.

5. Process according to claim 1, characterised in that lasers in the wavelength range from 157 nm to 10.6 μm are used.

6. Process according to claim 1, characterised in that the laser is a diode laser, Nd:YAG laser, YVO₄ laser or CO₂ laser.

7. Process according to claim 1, characterised in that the laser transfer takes place in continuous-wave or pulsed mode.

8. Support-film system comprising at least four layers lying one on top of the other, where the first layer is a support film (1) which is transparent to laser light, to which an energy-absorber layer (2) which is sensitive to laser light is applied, subsequently the detachment layer (3), optionally a sealing layer (4), the inscription medium (5) and optionally an adhesive layer (6) as the final layer is applied, characterised in that the inscription medium comprises uncopyable security features.

9. Support-film system comprising at least three layers lying one above the other, where the first layer is a support film (7) which is transparent to laser light and comprises one or more energy absorbers which are sensitive to laser light, subsequently the detachment layer (3), optionally a sealing layer (4), the inscription medium (5) and optionally an adhesive layer (6) as the final layer, characterised in that the inscription medium contains uncopyable security features.

10. Support-film system according to claim 8, characterised in that the uncopyable security feature is selected from the group IR pigment, IR dye, IR upconverter, IR downconverter, primary and secondary UV fluorescent pigment or dye, phosphorescent pigment, phosphorescent dye, laser dye, photochromic pigment, photochromic dye, thermochromic pigment, thermochromic dye, electroluminescent polymer, electroluminescent dye, optically variable pigment, pearlescent pigment, taggants, conductive pigment, holographic pigment, magnetic pigment or mixtures thereof.

11. Support-film system according to claim 8, characterised in that the detachment layer (3) consists of more than 95% by weight of natural or synthetic waxes having a melting point of 50-140° C.

12. Support-film system according to claim 8, characterised in that the sealing layer (4) consists of the polymers of styrene, vinyl chloride, methyl methacrylate or hydroxy-functional acrylates or polyvinyl fluoride.

13. Support-film system according to claim 8, characterised in that the inscription medium comprises polymer components, security feature(s), fillers and optionally colorants and/or additives.

14. Support-film system according to claim 8, characterised in that the adhesive layer (6) consists of more than 95% by weight of thermoplastics and fillers.

15. Support-film system according to claim 8, characterised in that the support film (1) or (7) consists of polyesters, polyolefins, polyamides, polyimides, polyacetals, polycarbonates, polyester-esters, polyether-esters, polymethyl methacrylates, polyvinylacetal, polyvinyl chloride, polystyrene, acrylonitrile-butadiene-styrene, acrylonitrile-styrene-acrylate, polyether ketones, polyether sulfones, copolymers and/or mixtures thereof.

16. Support-film system according to claim 8, characterised in that the laser-sensitive substance is selected from the group carbon, carbon black, metal oxides, graphite, anthracene, pentaerythritol, copper hydroxide phosphates, molybdenum disulfides, antimony(III) oxide and bismuth oxychloride, phyllosilicates, synthetic or natural mica, talc, kaolin, glass flakes, SiO₂ flakes, synthetic support-free flakes, flake-form metal oxides, silicon dioxide, LCPs (liquid crystal polymers), holographic pigments, pearlescent pigments, multilayered pigments based on flake-form substrates coated with two or more metals and/or metal oxides, conductive pigments, coated graphite flakes, metal flakes, spherical pigments comprising Al, Cu, Cr, Fe, Au, Ag and Fe, and mixtures thereof.

17. Process for the flexible and individual labelling of products, documents of value and security documents with counterfeiting- and copy-proof features according to claim 1, characterised in that a layer system is used.

18. Products, documents of value and security documents which contain uncopyable security features applied by the process according to claim 1.
